(19) United States
(12) Patent Application Publication
(10) Pub. No.: US 2007/0022108 A1
(43) Pub. Date: Jan. 25, 2007

(54) Predicate-logic retrieval system

(75) Inventor: Shinji Nakadai, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/187,539

(22) Filed: Jul. 22, 2005

(51) Int. Cl. G06F 17/30

(52) U.S. Cl. 707/4

(57) ABSTRACT

A predicate-logic retrieval system includes a predicate-logic retrieving section for receiving a predicate query and a metamodel-element built-in predicate (MMEBIP) storage section storing therein MMBEIPs and get-functions in association. If a predicate query includes a MMEBIP, the predicate-logic retrieval system retrieves a get-function from the MMBIP storage section, uses the get-function to retrieve predicate data from a repository storing therein data in a metamodel format, and executes variable identification for the predicate thus retrieved.

### BACKGROUND OF THE INVENTION

(a) Field of the Invention

The present invention relates to a predicate-logic retrieval system and, more particularly, to a predicate-logic retrieval system capable of predicate-logic retrieval of data from a repository storing therein the data in a complicated data storage format.

The present invention also relates to a predicate-logic retrieval method and a program using the predicate-logic retrieval method.

(b) Description of the Related Art

A predicate-logic retrieval system using a prolog program (Prolog) is known as one of logical retrieval systems. In general, upon receiving a predicate query specifying a concrete value, the Prolog retrieves data from a memory storing facts therein and returns a response as to whether or not the predicate holds, i.e., whether the predicate is true or false. The Prolog also returns, upon receiving a predicate query including a free variable, a condition under which the predicate holds. For example, if the Prolog receives a predicate query including a free variable “?x”, such as “human being (?x)”and if the memory stores therein data “human being (Suzuki)”, the Prolog returns “Suzuki” after identifying the free variable “x” as a concrete value, “Suzuki”.

Patent Publication JP-A-4(1992)-15827 describes a predicate retrieval system using the Prolog, wherein the retrieval system performs a predicate retrieval of data stored in a relational database provided outside the predicate retrieval system. FIG. 1 shows the conventional predicate retrieval system described in the patent publication. The predicate retrieval system 100 includes a prolog-program execution section 101 which may receive a predicate query, a built-in predicate storage section 102 which stores therein predicates suited to retrieving data from the relational database, and a relational database interface 103 which communicates with the relational database which stores therein data such as a table “math” tabulating the scores of students in mathematics.

In the described predicate retrieval system, specific predicates referred to as relational database predicates, “RDB predicates”, are used in addition to ordinary predicates. A RDB predicate is expressed by “RDB(—)”. The prolog-program execution section 101, upon receiving a predicate query including predicates other than the RDB predicates, consecutively executes identification of each predicate including a free variable as another predicate (or fact), which is stored in the memory of the prolog-program execution section 101. It is to be noted that the term “free variable” as used in this text means a variable having an unfixed value, and thus may assume any value. The term “identification” of a free variable is such that the free variable is construed as the same value as another variable or such that a concrete value is substituted for the free variable.

The relational database 104 stores therein a table “math” having a “Name” column and a “Mark” column. The built-in predicate storage section 102 stores therein RDB predicates. If the predicate query includes therein a RDB predicate, the prolog-program execution section 101 retrieves data from the relational database 104 via the relational database interface 103, and then executes identification of a free variable in the predicate query as a concrete value by using the retrieved data. In this identification, the concrete value is substituted for the free variable.

It is assumed here that the prolog-program execution section 101 receives a predicate query including two predicates, for example, “RDB(math(Name, Mark))” and “Mark>65”. Since these predicates are combined with “and”, the predicate query is true only when both the two predicates are true. The prolog-program execution section 101 first reads out a predicate, RDB(math(Name, Mark)), from the predicate query to judge whether or not the predicate thus readout is a RDB predicate. Since the built-in predicate storage section 102 stores therein a RDB predicate, “RDB(math(Name, Mark))”, the prolog-program execution section 101 judges that the predicate thus readout is a RDB predicate.

The prolog-program execution section 101 finds the “math” table in the relational database 104 to retrieve a value in the “Name” column and another value in the “Mark” column of the “math” table, as specified by the RDB predicate. In an initial state, the cursor is fixed onto the top row of the “math” table, and thus the prolog-program execution section 101 first retrieves a combination data (Suzuki, 60) from the first row of the “math” table, whereby the prolog-program execution section 101 substitutes “Suzuki” and “60” for “Name” and “Mark”, respectively, in the predicate, “RDB(math(Name, Mark))”, in the predicate query.

Subsequently, the prolog-program execution section 101 judges whether or not the next predicate, “Mark>65”, holds. In this case, since Mark(60)>65is not true, the prolog-program execution section 101 discards the combination data (Suzuki, 60) and again retrieves data from the “math” table in the relational database 104. The prolog-program execution section 101 retrieves a next combination data (Satoh, 80) from the next row of the “Name” and “Mark” columns, whereby the predicate “Mark>65” is satisfied.

The prolog-program execution section 101 recognizes that the predicate “Mark>65” is the last predicate, judges that the identification of free variables “Name” and “Mark” as “Satoh” and “80” satisfies the predicate query, and thus closes the processings for the received predicate query. In the above procedure, the predicate retrieval system 100 described in the patent publication can retrieve data from the external relational database 104 by storing therein RDB predicates used in the relational database 104, and other predicates, “Table” and “Column”, within the RDB predicates.

It is noted here that the database management uses a variety of management techniques. For example, in a network management system for managing a computer network system, the data to be managed in the management system are stored in a common information model (CIM) format. The CIM format is described in a literature entitled “A Practical Approach To WBEM/CIM Management” written by Chris Hobbs and published from Auerbach Publications. The CIM format uses a data storage format expressed by metamodel elements such as “Class”, “Association” and “Property”, unlike the relational database. The CIM format can manage data in a more complicated data storage format compared to the relational database that stores therein tables and columns, and thus is suited to managing data used in the network management system.

As described above, the technique described in the patent publication can retrieve data from the relational database by using the RDB predicates used in the relational database and stored in the own system. However, in this technique, the RDB predicates designed as built-in predicates are applicable only to the relational database storing therein tables each aggregating a plurality of columns, and are not applied to a repository wherein metamodel elements, such as “Class”, “Associator” and “Property”, define the data storage format. More generally, the technique described in the patent publication cannot use a repository having a data storage format different from the data storage format of the relational database in the processing for a predicate-logic retrieval.

### SUMMARY OF THE INVENTION

In view of the above problem in the conventional techniques, it is an object of the present invention to provide a predicate-logic retrieval system which is capable of retrieving a repository storing therein data in a more complicated data storage format compared to a relational database.

It is also an object of the present invention to provide a predicate-logic retrieval method used in s the predicate-logic retrieval system as described above and a program using such a method.

The present invention provides a predicate-logic retrieval system for responding to a predicate query to retrieve data from a repository, the repository storing therein data in a metamodel format defined using a plurality of metamodel elements, the retrieval system including: a predicate retrieving section for referring based on the predicate query to a predicate storage section, which stores therein a metamodel-element built-in predicate (MMEBIP) and at least one get-function in association, to retrieve the get-function corresponding to the predicate query; a data acquisition section for retrieving data from the repository based on the get-function; and a variable identification section for executing an identification processing and a back-tracking processing both based on data acquired by the data acquisition section, to return an answer for the predicate query, the answer including a true or false statement for the predicate query or a value of a free variable in the predicate query that provides a truth for the predicate query.

In accordance with the predicate-logic retrieval system of the present invention, the MMEBIP, obtained by modeling the data storage format of the repository without predicating the types of repositories, is used for retrieving data from the repository. Thus, upon receiving a predicate query in the predicate-logic retrieval system, the predicate-logic retrieving section retrieves from the predicate storage section a get-function corresponding to the MMEBIP in the predicate query. Then, the data acquisition section acquires data from the repository by using the get-function, thereby executing a predicate-logic retrieval. Thus, a repository storing data in a more complicated data format compared to the relational database, such as a CIM repository used in a computer network management system, can be used for the predicate-logic retrieval.

The above and other objects, features and advantages of the present invention will be more apparent from the following description, referring to the accompanying drawings.

### BRIEF DESCRIPTION OF THE DRAWINGS

FIG. 1 is a block diagram of a conventional logic retrieval system described in the patent publication.

FIG. 2 is a block diagram of a predicate-logic retrieval system according to a first embodiment of the present invention.

FIGS. 3A and 3B show tables stored in the MMEBIP storage section.

FIG. 4 is a flowchart of a processings from reception of predicate query to return of a response for the predicate query.

FIG. 5 is a detailed flowchart of the step A3 shown in FIG. 4.

FIG. 6 is a flowchart of a procedure of identification upon receiving a predicate query including a MMEBIP.

FIG. 7 is a block diagram of a predicate-logic retrieval system shown as an example of the first embodiment.

FIG. 8 is an exemplified diagram of a CIM metamodel depicted as a data storage format of the CIM repository shown in FIG. 7.

FIG. 9 is an exemplified diagram of a metamodel shown as a data storage format of a relational database.

FIG. 10 shows a concrete example of MMEBIPs stored in the MMEBIP storage section shown in FIG. 7.

FIGS. 11A to 11D are exemplified tables stored in the CIM MMEBIP storage section shown in FIG. 7.

FIG. 12 is an exemplified diagram of CIM objects stored in the CIM repository shown in FIG. 7.

FIG. 13 is an exemplified diagram of a rule stored in the rule storage section shown in FIG. 7.

FIG. 14 is a block diagram of a predicate-logic retrieval system according to a second embodiment of the present invention.

FIG. 15 is an exemplified diagram of a data storage format of the meta-conversion rule for converting an ordinary model to a metamodel.

FIG. 16 is an exemplified diagram of a meta-conversion rule stored in the meta-conversion rule storage section shown in FIG. 14.

FIG. 17 is an exemplified diagram of a rule stored in the rule storage section shown in FIG. 14.

FIG. 18 is a block diagram of a predicate-logic retrieval system according to a third embodiment of the present invention.

FIG. 19 is a block diagram of a predicate-logic retrieval system according to an example of the third embodiment.

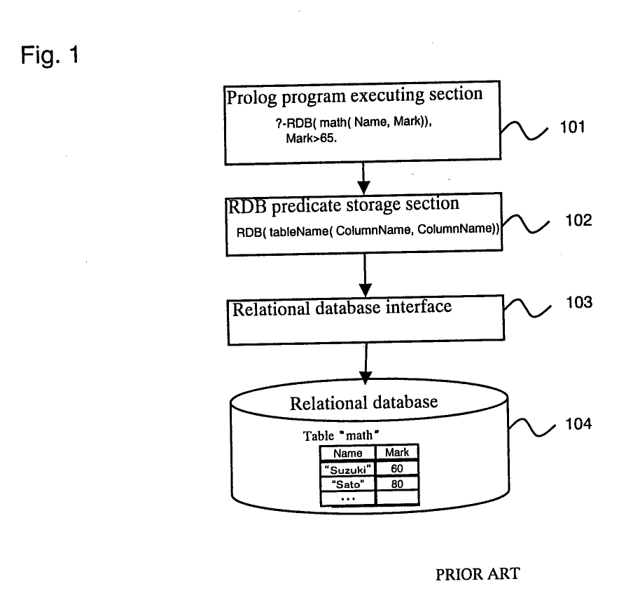

### PREFERRED EMBODIMENT OF THE INVENTION

In the predicate-logic retrieval system of the present invention, MMEBIPs are introduced corresponding to the metamodel elements used in the repository storing data to be retrieved, for achieving a predicate-logic retrieval processing using the data stored in the repository. For example, if the repository is a relational database, then predicates corresponding to “Table” and “Column” are prepared is and stored in the MMEBIP storage section. On the other hand, if the repository is a CIM repository, MMEBIPs corresponding to “Class” and “Association” are prepared and stored in the MMEBIP storage section.

As for variables (parameters) to be used in the MMEBIPs, a property value of an instance of a “Class”, such as “Table” and “Associator”, data of a type specified by the property value, a property value of “another instance” associated with the above-mentioned “instance”and/or the data of a type specified by the “another instance” can be used as the variables. It is to be noted here that the property of an instance includes the property of another instance from which the instance is derived. If the predicate query is a MMEBIP stored in the MMEBIP storage section, retrieval of data from the MMEBIP storage section provides a get-function for getting information by executing the function specified by the name of the get-function. The get-function is then used for retrieving necessary data from the repository. Thus, even if the repository stores therein data in a complicated data storage format, the predicate-logic retrieval system of the present invention can successfully retrieve data from the repository.

The predicate-logic retrieving section may retrieve a rule from a rule storage section storing therein a plurality of rules each having a head predicate and at least one body predicate, and replace a predicate in the predicate query with the body predicate of the rule retrieved, before retrieving data from the MMEBIP storage section. In this case, a predicate query can include a single predicate corresponding to the head predicate of a rule instead of a plurality of predicates corresponding to the body predicates of the rule. This simplifies the structure of the predicate query.

The body predicate of a rule may be a MMEBIP, whereas the head predicate of the same rule may be a model predicate derived and prepared beforehand from a MMEBIP. In this case, the predicate query can include a model predicate derived from the MMEBIP as well as another MMEBIP. This also simplifies the structure of the predicate query. In addition, a model predicate may be used as the body predicate of a rule, thereby further simplifying the body predicate of the rule.

In the back-tracking processing by the variable identification section, one of a plurality of data retrieved from the repository and not yet used in the preceding identification processing, may be used for a succeeding identification processing. If such a plurality of data can be retrieved from the repository by using a get-function, the plurality of data may be retrieved at once to be consecutively extracted one by one for the identification processing, or may be retrieved one by one from the repository to be subjected to the subsequent identification processing.

The predicate-logic retrieval system of the present invention or the repository may further include a data registry section which obtains data monitored for an equipment or a system to be monitored, converts the monitored data into a data format corresponding to the data storage format of the repository, and enters the converted data for registry in the repository. In this case, the data in the repository can be updated dynamically depending on the change of the state of the equipment or system monitored. For example, if a predicate query is issued for retrieving servers which operate on a specified operating system, information of the servers operating at the present moment and operating on the specified operating system may be retrieved by the predicate-logic retrieval system of the present invention.

Now, the present invention is more specifically described with reference to accompanying drawings.

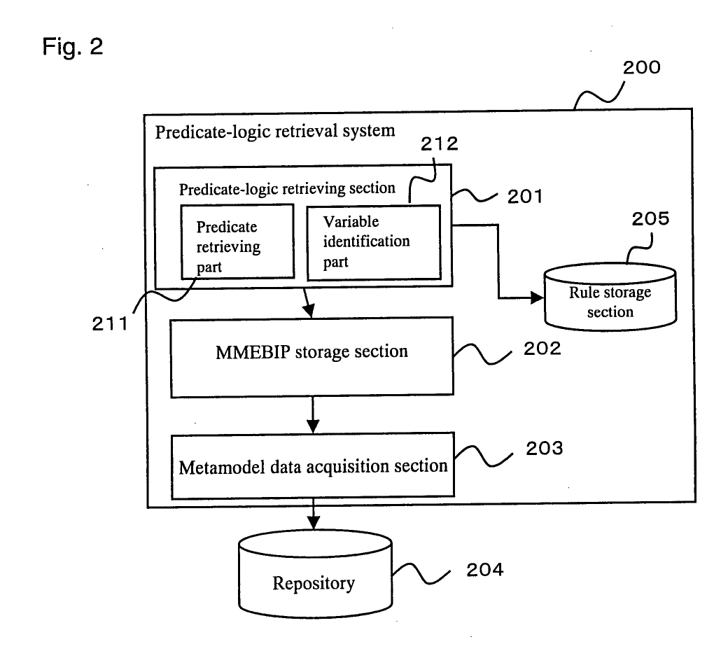

Referring to FIG. 2, a predicate-logic retrieval system, generally designated by numeral 200, receives a predicate-logic query from a user to retrieve data from an external repository 204, and returns to the user a response including a true or false statement as to the predicate logic in the predicate query or a value for a variable in the predicate under which the predicate in the predicate query holds.

The predicate-logic retrieval system 200 is configured as a computer system operating on a program. The predicate-logic retrieval system 200 includes a predicate-logic retrieving section 201 receiving a predicate query to return a response to the predicate-logic query, a metamodel-element built-in predicate (MMEBIP) storage section 202 storing therein MMEBIPs, and a metamodel data acquisition section 203 retrieving data from the repository 204.

The predicate-logic retrieving section 201 includes a predicate retrieving part 21 1, which receives a predicate query, and a variable identification part 212, which executes data identification of a variable in a predicate based on the received predicate query or the predicate retrieved by the predicate retrieving part 212. The predicate-logic retrieving section 201 executes a back-tracking processing if it fails in the variable identification for a predicate.

The term “back-tracking processing” as used herein means discarding a concrete value for a variable used in a failed identification in the processing for a predicate to return to the step before the processing for the predicate. The back-tracking processing may be equivalent to a processing by a conventional predicate-logic retrieval system known as Prolog.

The predicate-logic retrieval system 200 further includes a rule storage section 205 storing therein a plurality of rules each having a head predicate and at least one or zero body predicate. The rule typically defines that if all the body predicates of the rule are satisfied, then the head predicate of the rule is satisfied. Introduction of the rules allows the user to simplify the predicate query by specifying only a single rule as the predicate to be retrieved, instead of specifying a plurality of predicates which are included as the body predicates in the rule. In addition, the user can issue a predicate query including a predicate different from the predicates used in the repository 204 to be retrieved or the MMEBIP storage section 202.

The repository 204, from which data is retrieved by the predicate-logic retrieval system 200, stores therein data in a specific data storage format, as described hereinafter. In general, the data in a computer system can be expressed by “class”, “derivative”, “association” and “property”, which are prepared for this purpose. For example, the data storage format of a relational database is expressed by instances of “Class” identified as “Table”, instances of “Class” identified as “Column”, and instances of “Association” identified as “Comprehension of Column by Table”. The data storage format of a Java program is expressed by instances of “Class” identified as “Class”, instances of “Class” identified as “Constractor”, and instances of “Association” identified as “Comprehension of Constractor by Class” referring to Class and Constractor. The models expressing the data storage formats are herein referred to as metamodels, and instances of “Class” such as identified as “Column” are referred to as metamodel elements.

For clarifying the relationship between metamodels, the defined levels of types are classified, and the level of the type is specified. The term “defined level” of a type means the definition of relationship wherein the type of a lower-level element is defined by a higher-level element. If the defined levels of type include four levels including level-0 to level-3, the metamodel itself corresponds to level-3.

In the case of a relational database, for example, the information that a value of a “Name” column in a “math” table is “Suzuki” belongs to level-0, the information that the “math” table aggregates “Name” columns belongs to level-1, the information that a “Table” element aggregates “Column” elements belongs to level-2, and the information that an “Element” element aggregates “Another Element” elements belongs to level-3. In the ranks including level-0 to level-2, a lower-level element is expressed by the term defined for a higher-level element.

In the following description, the data storage format of the repository 204 is defined by using “class”, “derivative”, “association” and “property”. This means that “class”, “derivative”, “association” and “property” elements belong to level-3. These classes are different from those in the Java and CIM. It is to be noted that the classification of defined levels of models may correspond to “Meta-level” described in “MDA Mode Driven Architecture” by David Frankel from “SIB Access”or the level-0 to level-3 may correspond to M0 to M1 in Meta-model.

In the present embodiment, MMEBIPs are introduced corresponding to elements of metamodels obtained by modeling the data storage format of the repository 204 from which the predicate-logic retrieval system 200 retrieves data, for achieving predicate-logic retrieval using the data stored in the repository. As the variable in a MMEBIP, specified is a model or instance defined by the metamodel-element in the MMEBIP or a model or instance of another metamodel-element associated with the metamodel element. The MMEBIP storage section 202 stores therein tables which manage the correspondence between MMEBIPs and get-functions used for retrieving data from the repository 204. The correspondence includes a correspondence between a MMEBIP name and metamodel information and also a correspondence between a parameter in the MMEBIP and a parameter or a return value of the get-function.

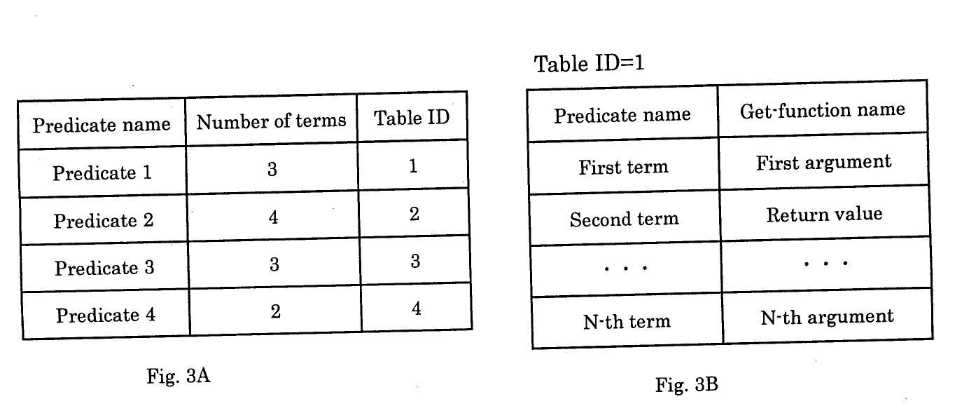

FIGS. 3A and 3B show tables stored in the MMEBIP storage section 202. The tables stored therein include a first table shown in FIG. 3A, which manages correspondence between the MMEBIP, number of terms and table ID, and a second table shown in FIG. 3B, which manages correspondence between the get-function, sequential number of predicate and argument for the get-function.

The metamodel data acquisition section 203 issues a meta-level data request to the repository 204 by using a get-function. The repository 204 receives and accepts the meta-level data request, reads the model name attached as the argument for the get-function, extracts the instance information corresponding to the model name, and returns the instance information thus extracted to the metamodel data acquisition section 203 that transmitted the meta-level data request.

The predicate-logic retrieving section 201, upon receiving a predicate query, refers to the MMEBIP storage section 204 to thereby judge whether or not the predicate query includes a MMEBIP. If the predicate query includes a predicate other than the MMEBIPs, the predicate-logic retrieving section 201 executes a variable identification processing using the facts stored in the memory thereof. The predicate-logic retrieving section 201 may also execute a variable identification processing using a rule stored in the rule storage section 205, if the predicate query includes a predicate which is defined in the rule.

If the predicate-logic retrieving section 201 judges that the predicate query includes a MMEBIP, then the predicate-logic retrieving section 201 extracts a get-function from the MMEBIP storage section 202, obtains data from the repository by way of the metamodel data acquisition section 203 and using the get-function, and performs variable identification. In this procedure, if the variable in the predicate is identified as a concrete value before acquisition of data from the repository 204, the predicate-logic retrieving section 201 substitutes the concrete value for the variable in the predicate to use the concrete data for acquisition of data from the repository 204.

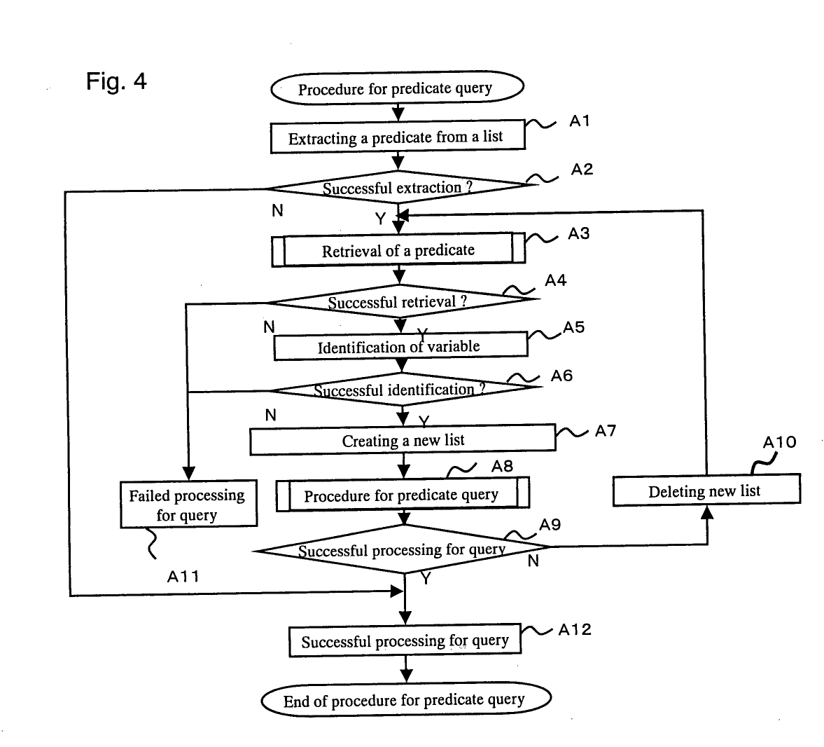

FIG. 4 shows a procedure from the step of receiving a predicate query to the step of returning a response to the predicate query in the predicate-logic retrieval system of FIG. 2. When a predicate query is received, the predicate query is delivered to the predicate-logic retrieving section 201. The predicate-logic retrieving section 201 has a memory for storing therein a list of predicates. The predicate-logic retrieving section 201 first adds the predicate or predicates of the received predicate query to the list in the memory, and performs the procedure shown in FIG. 4 for the list of the predicates.

The predicate-logic retrieving section 201 extracts a predicate in the list (step A1). The predicate-logic retrieving section 201 judges whether or not the extraction of a predicate is successful (step A2). If there is no predicate in the list, the predicate-logic retrieving section 201 returns a statement for closing the procedure for the predicate query (step A12). In this case, since the predicate-logic retrieving section 201 judges a successful extraction of the predicate in step A2, and the predicate-logic retrieving section 201 retrieves a predicate having a name same as the name of the extracted predicate (step A3). This retrieval is effected to retrieve a fact stored in the memory of the predicate-logic retrieving section 201, a head predicate of a rule stored in the rule storage section 205, and a MMEBIP stored in the MMEBIP storage section 202.

The predicate-logic retrieving section 201 judges whether or not the retrieval is successful (step A4). If the retrieval is successful, predicate-logic retrieving section 201 executes variable identification using the facts stored in the memory thereof, the rule stored in the rule storage section 205, or the data stored in the repository 204 from which the data is to be retrieved (step A5). Thereafter, the predicate-logic retrieving section 201 judges whether or not the variable identification is successful (step A6). The predicate-logic retrieving section 201, if it judges the retrieval is unsuccessful in step A4 or the variable identification is unsuccessful in step A6, returns a response statement that the predicate query is unsuccessful (step A11). The predicate-logic retrieving section 201, if it judges that the variable identification is successful, applies the concrete value obtained by the variable identification to all the predicates stored in the list, thereby storing the resultant predicates as a new predicate list (step A7).

The predicate-logic retrieving section 201 then executes processing for a predicate query in the new list (step A8) . In this procedure of step A8, the processing for the predicate query shown in FIG. 4 is recursively called. If a result for the predicate query is returned from the processing thus recursively called, the predicate-logic retrieving section 201 judges whether or not the processing for the predicate query in step A8 is successful (step A9).

The predicate-logic retrieving section 201, if it judges the processing for the predicate query in the called step A8 is successful, judges that the processing in the current calling step is successful (step A9), and returns a statement of successful processing for the predicate query (step A12). On the other hand, if the predicate-logic retrieving section 201 judges that the step A8 is unsuccessful, deletes the new list prepared in step A7 (step A10), returns to step A3 for retrieving another predicate. In this retrieval, the predicate extracted before is not extracted.

If a rule is retrieved from the rule storage section 205 in step A3, the list prepared in step A7 generally has a list length equal to or longer than the original list length. However, if a single predicate considered as a fact is retrieved in step A3, the resultant list length is shorter than before. More specifically, if a fact is retrieved in step A3, the predicate query in step A8 has a list length shorter than before. This eventually results in an empty list of the predicates. If a processing for a predicate query is recursively called in step A8 for the empty list, the called processing advances from step A2 to step A12, whereby a statement of successful processing for the predicate query is returned. After the predicate query for the final predicate is judged successful, the processing for the predicate query in the recursively calling stage is judged successful, whereby a final statement of the successful processing for the issued predicate query is returned from the predicate-logic retrieving section 201 (step A12).

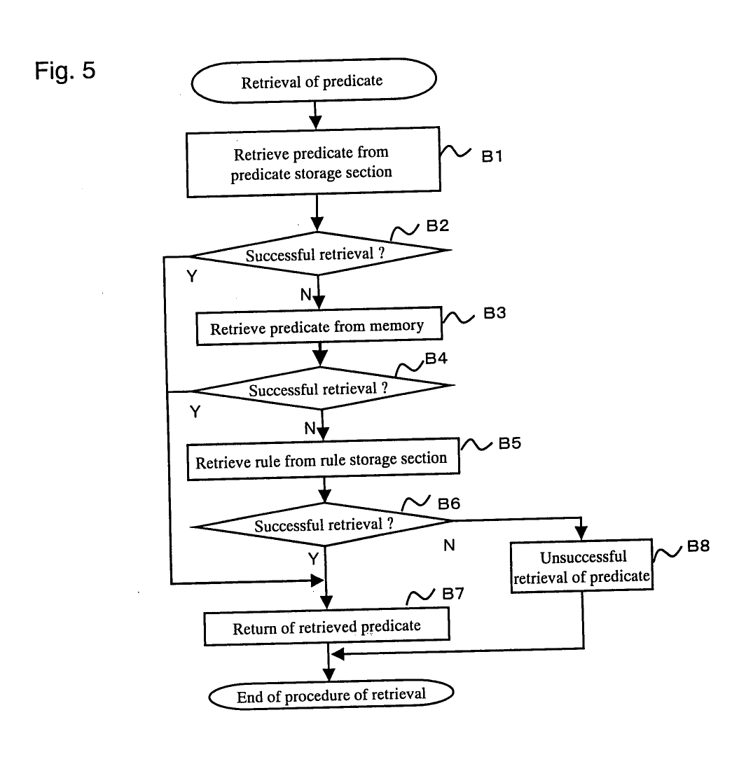

FIG. 5 shows details of the procedure in step A3. In the predicate retrieval, the predicate-logic retrieving section 201 refers to the MMEBIP storage section 202 (step B1) to examine whether or not the MMEBIP storage section 202 stores therein a predicate having a predicate name coinciding with the name of the predicate to be retrieved. The predicate-logic retrieving section 201 judges whether or not this predicate retrieval is successful (step B2), and returns the retrieved MMEBIP, if it is successful.

The predicate-logic retrieving section 201, if it judges the retrieval is unsuccessful in step B2, then refers to the memory thereof (step B3) to examine whether or not the memory stores therein a fact having a predicate name corresponding to the predicate to be retrieved. The predicate-logic retrieving section 201 judges whether or not this predicate retrieval in step B3 is successful (step B4), and if it is successful, advances to step A7 to return the retrieved fact as a predicate.

The predicate-logic retrieving section 201, if it judges the retrieval in step B4 is unsuccessful, then refers to the rule storage section 205 (step B5), to examine whether or not the rule storage section 205 stores therein a rule having a head predicate coinciding with the predicate to be retrieved. The predicate-logic retrieving section 201 judges whether or not this retrieval is successful (step B6), and advances to step B7 to return the retrieved predicate if it is successful. The predicate-logic retrieving section 201, if it judges this retrieval is unsuccessful, returns a state of unsuccessful predict retrieval (step B8).

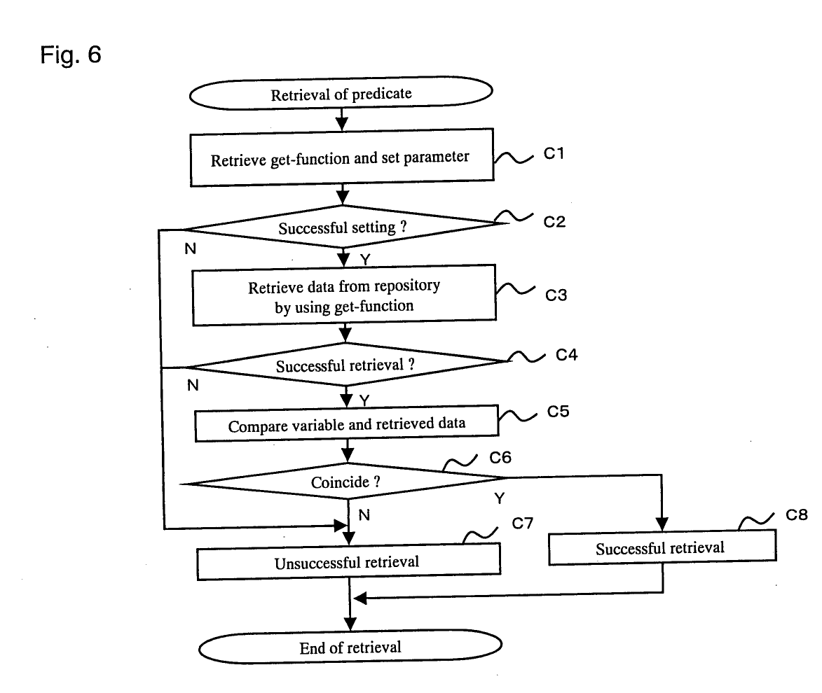

FIG. 6 shows a procedure for variable identification in the case of the predicate query including a MMEBIP. If the retrieval in step A3 reveals that the predicate query includes a MMEBIP, the predicate-logic retrieving section 201 executes variable identification of step A5, as detailed hereinafter. It is to be noted that if the retrieved predicate is an ordinary predicate retrieved from the memory in the predicate-logic retrieving section 201 or the predicate of a rule retrieved from the rule storage section 205, the predicate-logic retrieving section 201 executes variable identification similar to the procedure of the ordinary predicate-logic retrieval, known as Prolog.

In the variable identification of step A5 which is detailed in FIG. 6, the predicate-logic retrieving section 201 first refers to the table stored in the MMEBIP storage section 202 and representing correspondence between the MMEBIPs and the get-functions. The predicate-logic retrieving section 201 retrieves a get-function and sets parameters for the retrieved get-function (step C1). In this step C1, if there is a free variable identified as a concrete value, the concrete value is set as the parameter of the get-function. Subsequently, the predicate-logic retrieving section 201 judges whether or not the setting of the parameters is successful (step C2), and if it is unsuccessful, returns a statement of an unsuccessful identification.

If the setting of parameters is successful in step C1, the predicate-logic retrieving section 201 allows the metamodel acquisition section 203 to retrieve data from the repository 204 by using the get-function (step C3). The predicate-logic retrieving section 201 then judges whether or not the data retrieval from the repository 204 is successful (step C4). If the retrieval from the repository 204 is unsuccessful, the predicate-logic retrieving section 201 advances to step C7 to return a statement of an unsuccessful identification.

If data is retrieved from the repository 204, the predicate-logic retrieving section 201 compares the retrieved data and the variable in the predicate (step C5), judges whether or not the retrieved data satisfies the variable in the predicate (step C6). In the comparison of step C5, if the second term in the predicate corresponds to a returned value, as shown in FIG. 3B, the predicate-logic retrieving section 201 compares the retrieved data and the value of the second term in the predicate. The predicate-logic retrieving section 201, if it judges that the retrieved data satisfies the predicate, substitutes the retrieved data in the predicate, returning a statement of a successful identification (step C8). If the retrieved data does not satisfy the predicate, the predicate-logic retrieving section 201 advances to step C7 to return a statement of an unsuccessful identification.

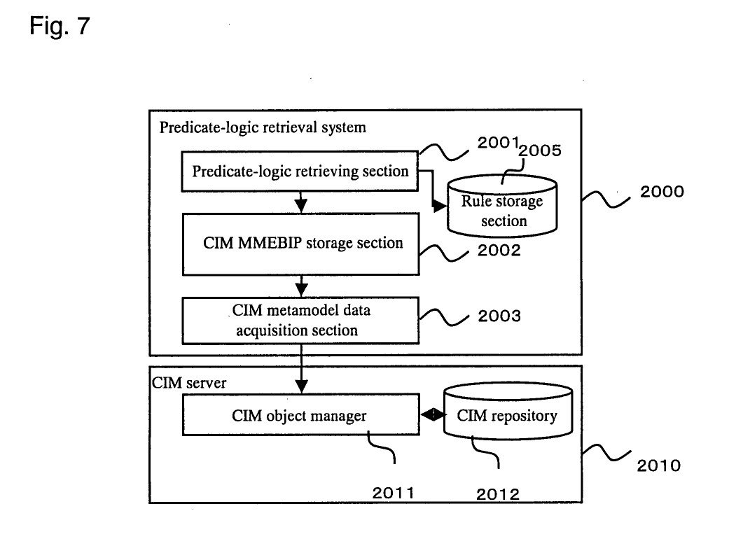

A concrete example will be described hereinafter. FIG. 7 shows a predicate-logic retrieval system according to an example of the first embodiment. The predicate-logic retrieval system 2000 operates in association with a CIM server 2010. The predicate-logic retrieval system 2000 includes a predicate-logic retrieving section 2001, a CIM MMEBIP storage section 2002, a CIM-metamodel-data acquisition section 2003, and a rule storage section 2005. The CIM server 2010 corresponds to the repository 204 shown in FIG. 2, and includes therein a CIM object manager 2011 and a CIM repository 2012.

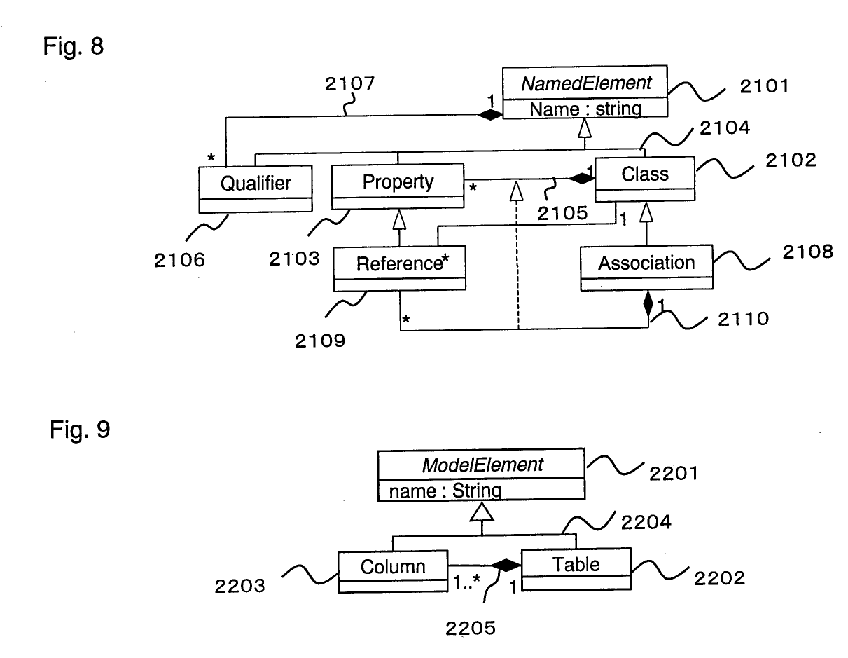

FIG. 8 shows the data storage format of part of a CIM metamodel stored in the CIM repository 2012. In the CIM metamodel, the schema is defined using “Class” 2102, “Property” 2103, “Association” 2108 and “Qualifier” 2106, each of which has a “NamedProperty” (property in “NamedElement” 2101) 2104 and aggregates “Qualifiers” 2106 (2107). In addition, an “Association” 2108 aggregates “Properties” 2106 (2105), and also aggregates “References” 2109 each of which represents a pointer to “Class” 2102 (2111).

On the other hand, a relational database, as shown in FIG. 9, stores therein a “Table” metamodel 2202 and a “Column” metamodel 2203, each of which has a “NamedProperty” (property in “ModelElement” 2201) (2204), and a “Table” aggregates “Columns” 2204 (2205). Thus, CIM repository stores therein a metamodel different from the metamodel stored in the relational database.

It is considered here that the technique described in the patent publication mentioned before is applied to a CIM repository for execution of predicate-logic retrieval. In this technique, since the types of the repositories are used as built-in predicates, CIM predicates must be prepared and stored in the predicate memory. Assuming that a variable in a predicate represents an association between the “Class” and the “Property” in the CIM predicates, similarly to the case of the “Table” and “Column” in the RDB predicates described in the patent publication, it is possible to obtain a value for “Property” by a predicate retrieval. However, a value for “Qualifier”, which is aggregated (such as denoted by 2107 in FIG. 8) by “Property” or “Class”, cannot be obtained by a predicate retrieval.

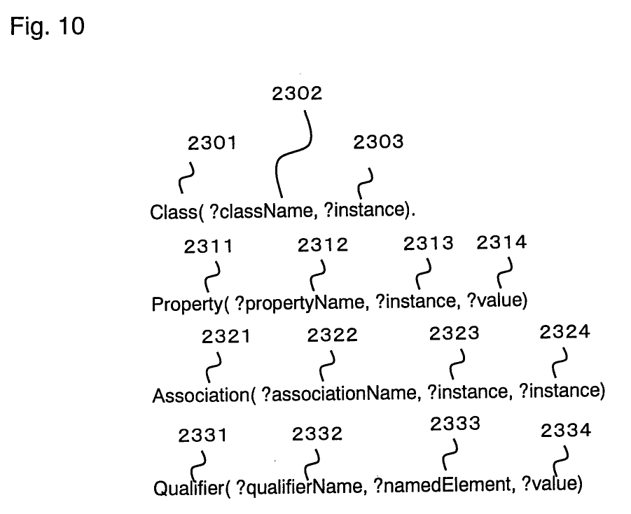

Thus, in the present example, MMEBIPs, such as shown in FIG. 10, are prepared. These MMEBIPs correspond to metamodel elements in the CIM repository 2012 and stored in the CIM MMEBIP storage section 2002. The MMEBIPs represent the metamodel elements shown in FIG. 8. For example, the predicate 2301 in FIG. 10 corresponds to the metamodel element name 2102 in FIG. 8.

As a variable in a MMEBIP, either one of the following first through third variables is provided. First, a “Property” of a metamodel element may be provided as a variable. As shown in FIG. 8, since each of all the metamodel elements is a subclass of a “NamedElement” class, the metamodel element has a “Name” property. Thus, a variable representing the property thereof is provided for a term of the metamodel element. For example, the first term 2302 of the “Class” predicate 2301 corresponds to the “Name” property thereof, and may be provided with a “Class” model name such as “ComputerSystem”.

Second, a model or instance defined by a metamodel element configuring a predicate may be provided as a variable. For example, the “ComputerSystem” class is defined by a “Class” metamodel, whereas an instance of “CompuerSystem. Name=“Server00”” class is defined by a “ComputerSystem” class. Thus, a “Class” predicate may include a variable representing the model or instance.

Third, another metamodel having an association with the subject metamodel in the predicate or a model or instance of the another metamodel may be provided as a variable. For example, a “Property” predicate 2311 in FIG. 10 may be provided with an instance of “Class” to which the “Property” belongs, in addition to a “Property” name 2312. This is based on the relationship (2105 in FIG. 8) wherein a “Property” metamodel element 2103 is aggregated by a “Class” metamodel element 2102.

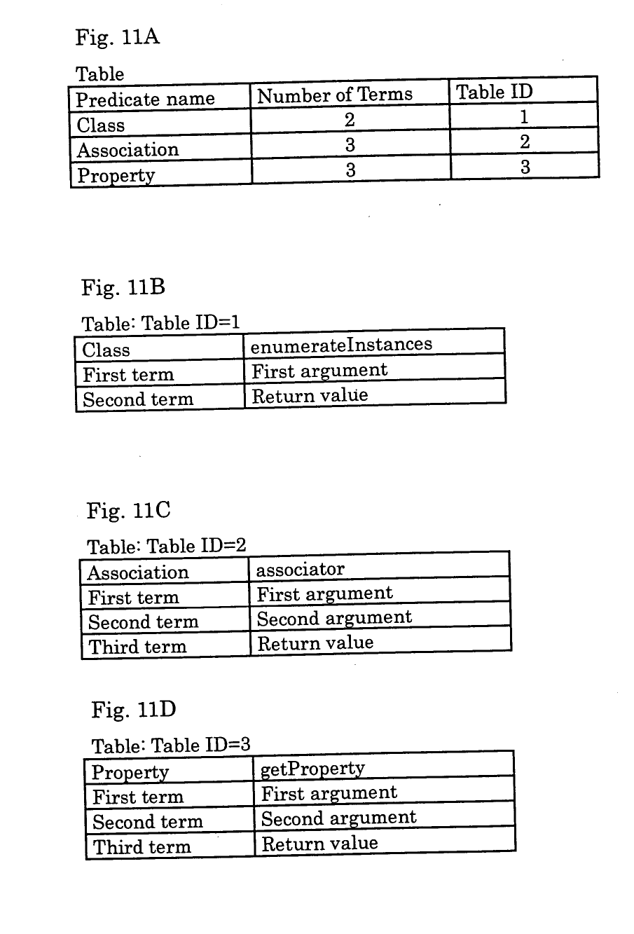

FIGS. 11A to 11D show an example of tables stored in the CIM MMEBIP storage section 2002. The CIM MMEBIP storage section 2002 stores therein a table shown in FIG. 11A to manage the correspondence between each MMEBIP name and parameters thereof, wherein the number of terms in the table corresponds to the number of variables or parameters of the each MMEBIP.

The CIM MMEBIP storage section 2002 manages the correspondence between each MMEBIP and the get-function of the MMEBIP and parameters in the get-function. In this example, the “Class” predicate corresponds to an “enumerateInstance” get-function, and the first argument of the get-function corresponds to the first term of the predicate (FIG. 11B). In addition, an “Association” predicate corresponds to an “associators” get-function, wherein the first argument of the get-function corresponds to the first term of the predicate, and the second argument of the get-function corresponds to the second term of the predicate (FIG. 11C).

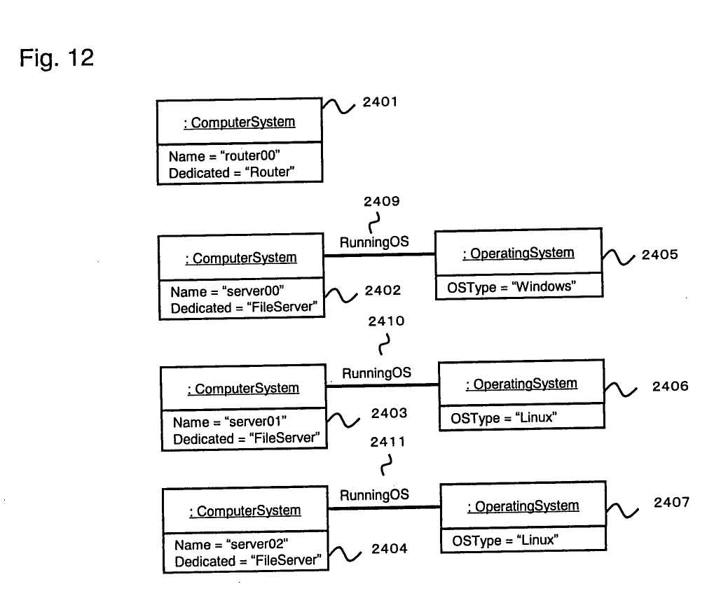

FIG. 12 shows a CIM object stored in the CIM repository 2012. The CIM repository 2012 stores therein instances 2401 to 2404 of a “ComputerSystem” class, and instances 2405 to 2407 of an “OperatingSystem” class. There are also shown “RunningOS Association” instances 2409 to 2411 connecting between a “ComputerSysetem” instance 2402 and an “OperatingSystem” instance 2405, between a “CompuetrSystem” instance 2403 and an “OperatingSystem” instance 2406 and between a “ComputerSysatem” instance 2404 and an “OperatingSystem” interface 2407.

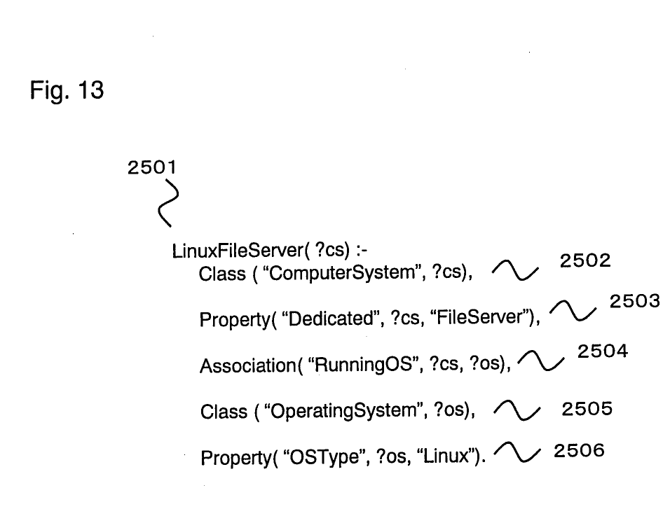

FIG. 13 shows an example of a rule stored in the rule storage section 2005. The rule shown therein corresponds to a retrieving formula for enumerating file servers operating on a Linux operating system. The rule includes a head predicate 2501, “Linux file server”and a plurality of body predicates 2502 to 2506. For example, the first body predicate 2502, “Class”is true if the “Class” name of the second term, free variable “?cs”, is equal to the first term, “ComputerSystem”, of the body predicate 2502. Similarly, the second body predicate 2503, “Property”, is true if a value of the property of the first term, “Dedicated”, is equal to the third term, “FileServer”of the body predicate 2503 with respect to the second term, “free variable ?cx”. The predicate 2501, “LinuxFileServer”, is true if all the body predicates 2502 to 2506 are true.

In the following example, an operation of the predicate-logic retrieval system of FIG. 7 for responding to a predicate query, “LinuxFileServer” (?cx)”, will be described. The predicate-logic retrieving section 2001 stores the predicate query, “LinuxFileServer” (?cx)”, in a list, and extracts one of the predicates stored in the list (step A1 in FIG. 4). In this first extraction, the predicate is successfully extracted at any time, and the process advances to step A3, wherein retrieval of a predicate having a name same as the name of the extracted predicate is attempted in the retrieval system. In the exemplified case, since the rule storage section 2005 stores therein a rule 2501, shown in FIG. 10, having a head predicate, “LinuxFileServer”, the rule 2501 is returned as a result of the retrieval.

The predicate-logic retrieving section 2001, upon a successful retrieval of a predicate, identifies the free variable “?x” in the predicate query as a free variable “?c” in the retrieved rule 2501. This identification does not provide any inconsistency because both the parameters are the free variables, and thus it is judged in step A6 that the identification is successful. The predicate-logic retrieving section 2001, after judging a successful identification, creates a new list of predicates including the body predicates 2502 to 2506 of the rule 2501 (step A7), and recursively calls the processing of FIG. 4 for the predicate query of the created new list.

In the recursively called processing for the predicate query, the predicate-logic retrieving section 2001 extracts the first body predicate 2502, “Class”, from the list of the body predicates 2502 to 2506, and executes a retrieval processing for the first body predicate 2502. Since the CIM MMEBIP storage section 2002 stores therein a MMEBIP 2301, “Class”, which has a name equal to the name of the extracted body predicate 2502, the predicate-logic retrieving section 2001 successfully retrieves the “Class” predicate.

After retrieving the “Class” predicate 2502, the predicate-logic retrieving section 2001 advances to step A5, to execute an identification processing for he predicate 2502 retrieved in step A1. In the identification processing, the predicate-logic retrieving section 2001 first retrieves a get-function corresponding to the predicate 2502, determining the parameters in the predicate 2502 (step C1 in FIG. 6). In the processing of step C1, the predicate-logic retrieving section 2001 first refers to the table shown in FIG. 11A, to retrieve “Table ID=1” therefrom, and then retrieves a get-function, “enumerateInstances”, from the table having a table ID=1 shown in FIG. 11B. The predicate-logic retrieving section 2001 sets the first argument of the get-function at the first term, “ComputerSystem”of the predicate 2502 to succeed the setting of the parameter.

The predicate-logic retrieving section 2001, upon succeeding the setting of the parameter, indicates the CIM-metamodel-data acquisition section 2003 to execute a retrieval using the get-function and the CIM server 2010. In the CIM server 2010, the CIM-object management section 2010 responds to the retrieval request and extracts instances 2401 to 2404 of the “ComputerSystem” from the CIM repository 2012, thereby returning instances 2401 to 2404 to the CIM metamodel-data acquisition section 2003.

The CIM metamodel-data acquisition section 2003 temporarily stores therein the instances 2401 to 2404 returned from the CIM-object management section 2010. The predicate-logic retrieving section 2001 extracts one of the instances 2401 to 2404, i.e., instance 2401, “ComputerSystem. Name=“router00””, and compares the free variable “?c” obtained as a returned value from the table shown in FIG. 11B and the thus extracted instance 2401 in step C5. Since this step identifies a free variable as a concrete instance, the predicate-logic retrieving section 2001 judges that the instance 2401 satisfies the variable in the predicate (step C6), and returns a statement of a successful identification (step C8). Thus, the free variable “?cs” of the “Class” predicate is identified as the concrete value of the instance 2401.

The predicate-logic retrieving section 2001, upon a successful identification, creates a new list of predicates 2503 to 2506 following the predicate 2502 which is successfully identified. In this new list, the predicate-logic retrieving section 2001 replaces the free variable “?cs” in the predicates 2503 to 2506 with the concrete value of the instance 2401 successfully identified in the predicate 2502. Subsequently, the predicates 2503 to 2506 in the resultant new list are subjected to a recursively called processing for the predicate query one by one.

In the recursively called processing for the predicate query, the predicate-logic retrieving section 2001 extracts a “Property(“Dedicated”, ?cs, “FileServer”)” predicate 2503, and executes retrieval and identification processings therefor. In the identification processing, the predicate-logic retrieving section 2001 refers to the tables, shown in FIGS. 11A and 11B, stored in the MMEBIP storage section 2002, to retrieve a get-function, “GetProperty”, determines the parameter thereof (step C1), and executes retrieval using the retrieved get-function (step C3).

The predicate-logic retrieving section 2001 executes a retrieval using the get-function, “GetProperty”, to obtain a value for the property specified by the first term, “Dedicated”, of the “Property” predicate with respect to the instance 2401 specified by the second term. Since the “Dedicated” property of the instance 2401, “ComputerSystem. Name=“rourtee00”” is “Router” in this example, the get-function returns a value “Router”. Since the returned value corresponds to the third term in FIG. 11C, the predicate-logic retrieving section 2001 compares the returned value, “Router”, and the third term, “Server”, of the “Property” predicate in step C5. In this comparison, since both the values are inconsistent with one another, the predicate-logic retrieving section 2001 returns a statement of a failed identification, as a result of which the process advances from step A6 to step A11 in FIG. 4, thereby returning a response statement of a filed predicate query to the processing stage that recursively called the processing for the predicate query.

After the recursively called processing for the predicate query is failed, the predicate-logic retrieving section 2001 returns to the calling processing stage and advances to step A10 thereof, to discard the list prepared by replacing the free variable “?cs” with the instance 2401. The process then returns to step A3 in FIG. 4, to again execute the processing for the retrieval of the predicate 2502, “Class”. This retrieval is already achieved in the last retrieval, and thus is judged successful in step A4.

The predicate-logic retrieving section 2001 advances to step A5, to execute identification of another instance. The another instance is extracted as one of three remaining instances 2402 to 2404 among the four instances 2401 to 2404, one of which, instance 2401, is already extracted and resulted in a failed identification. In this example, the predicate-logic retrieving section 2001 extracts the instance 2402, “ComputerSystem. Name=“Server00””, among the remaining instances 2402 to 2404, and identifies the free variable “?cs” as the concrete value of the instance 2402.

The predicate-logic retrieving section 2001, upon judging a successful identification in step A6, creates a new list of predicates in step A7 by substituting the concrete value of the instance 2402 for the free variable “?cs” in the instances 2503 to 2506. Subsequently, the process advances to step A8 to recursively call the processing for the predicate query of the new list. In the recursively called processing for the predicate query, the predicate-logic retrieving section 2001 extracts one of the instances, e.g., an instance 2503, wherein the free variable “?cs” is replaced with the instance 2402, and executes retrieval in step A3 and identification in step A5.

In step A5, since the “Dedicated” property of the instance 2402, “ComputerSystem. Name=“server00”” is “FileServer” as shown in FIG. 12, this predicate 2503 is judged true, resulting in a successful identification. The predicate-logic retrieving section 2001 creates a new list of predicates including instances 2504 to 2506 while excluding the instance 2503 successfully identified (step A7), and then recursively calls the processing for the predicate query (step A8).

In the recursively called processing for the predicate query, the predicate-logic retrieving section 2001 extracts one of the predicates, predicate 2504, in step A1, and finds an “Association” predicate in the CIM MMEBIP storage section 2002 to succeed a retrieval. In the subsequent identification, the predicate-logic retrieving section 2001 identifies the free variable “?os” in the predicate 2504 as the concrete value of the “OperatingSystem” instance 2405, which is associated with the instance 2402 via a “RunningOS” associator by using a get-function, “associators”, to succeed the identification. Thereafter, the free variable “?os” in the predicate 2505 and 2506 is replaced with the instance 2405 to prepare a new list in step A7, and a processing for the predicate query is recursively called for the new list.

In the recursively called processing for the predicate query, the predicate-logic retrieving section 2001 extracts the predicate 2505 and executes retrieval and identification thereof. The retrieval and identification are successful because the predicate 2505 is a “Class” predicate 2301 and the class of the instance 2405 for which the free variable “?os” is identified is “OperatingSystem”. Thereafter, the predicate-logic retrieving section 2001 creates a new list including the predicate 2506, and recursively calls a processing for the predicate query.

In the recursively called processing for the predicate query, the predicate-logic retrieving section 2001 extracts the predicate 2506 from the new list, and executes retrieval and identification for the extracted predicate. In the retrieval, a “Property” predicate 2301 is found in the CIM MMEBIP storage section 2002 to succeed the retrieval of predicate 2506. In the identification, the predicate-logic retrieving section 2001 uses a get-function “GetProperty” to obtain a “OSType” property of the instance 2405, and compares the “OSType” property, “Windows”, thus obtained and the third term, “Linux”, of the predicate 2506. The comparison reveals that both are inconsistent with one another, failing in the identification and thus fails in the processing for the predicate query for the new list including the predicate 2506.

The predicate-logic retrieving section 2001, upon judging a failed identification for the list including the predicate 2506, returns to the recursively calling processing stage for the predicate query of the list including the predicates 2505 and 2506, discards the list including the predicate 2506 in step A10, and returns to step A3. In the identification of the predicate 2505, since retrieval of data other than the data previously retrieved is not possible from the CIM repository 2012 by using the instance 2405 for which a concrete value is substituted, the identification is judged failed, and a statement of a failed processing for the predicate query is returned. The failures of the recursively called processings result in the failures of the recursively calling processing stages one by one in the order of the recursively calling, whereby the list of the predicates 2505 and 2506 and the list of the predicates 2504 to 2506 are consecutively discarded in this order.

The predicate-logic retrieving section 2001 then returns to the processing for the predicate query of the list including the predicates 2503 to 2506, identifying the free variable “?cs” in the predicate 2503 as the concrete value of the instance 2403, “ComputerSystem. Name=“server01””. The predicate-logic retrieving section 2001 then creates a new list by identifying the free variable “?cs” in the. predicates 2503 to 2506 as the concrete value of the instance 2403, recursively calling a processing for the predicate query of the thus created list.

As shown in FIG. 12, the “Dedicated” property of the instance 2403 is “FileServer”. Accordingly, both retrieval and identification for the predicate 2503 are succeeded. For the retrieval and identification of the predicate 2504, the free variable “?os” therein is identified as the concrete value of the “OperatingSystem” instance 2406 which is associated with the instance 2403 via the “RunningOS” associator. In addition, the retrieval and identification of the predicate 2505 assures that the instance 2406 is an “OperatingSystem” instance.

In the processing for the predicate query of the predicate 2506, the predicate-logic retrieving section 2001 retrieves the “OSType” property of the instance 2406 by using the get-function. The retrieved “OSType” property, “Linux”, coincides with the third term of the predicate 2506, and thus the predicate-logic retrieving section 2001 succeeds in the identification of the predicate 2506. Although a new list is created in step A7, the predicate 2506 is a final predicate and thus the created list includes no predicate therein. In the processing for the predicate query of the empty list thus created, the predicate-logic retrieving section 2001 judges a filed extraction of a predicate in step A2, and advances to step A12, returning a response statement of a successful processing for the predicate query.

After the return of the statement of the successful processing, there arise consecutive successful processings for the predicate queries of the list including the predicate 2506, the list including the predicates 2505 and 2506, the list including the predicates 2504 to 2506, the list including the predicates 2503 to 2506, the list including the predicates 2502 to 2506 and the list including the predicate 2501. These successful processings allow identification of the free variable “?cs” of the predicate 2501 as the instance 2403, “ComputerSystem. Name=“server01””, providing a judgement that the predicate query including the predicate 2501 holds.

If a query whether or not there is any instance other than the instance 2403 that allows the predicate 2501 to hold is then issued, the predicate-logic retrieving section 2001 extracts the instance 2404, “ComputerSystem. Name=“server02””, from the four instances 2401 to 2404, that is obtained from the CIM server 2010 by the identification of the predicate 2502 and not yet extracted, and executes identification of the free variable “?cs”. It is noted here that this instance 2404 has a “Dedicated” property, “FileServer”, similarly to the instance 2403, and that the instance 2407 associated with the instance 2404 via a “RunningOS” associator has an “OSType” property, “Linux”. Thus, all the predicates 2503 to 2506 hold, as is the successful case with respect to the instance 2403. Accordingly, the predicate 2501 is judged to hold for the instance 2404, in addition to the instance 2403.

As described above, in the present embodiment, the MMEBIPs are stored beforehand in the MMEBIP storage section 202 shown in FIG. 2. If the predicate query includes a MMEBIP, a get-function is retrieved from the MMEBIP storage section 202, and is used to retrieve data from the repository 204. Based on the retrieved data, a retrieval result whether or not the predicate query holds is returned as a response thereto, or a concrete instance under which the predicate query holds is returned as a response thereto after identifying the free variable in the predicate query as the concrete instance. The use of the MMEBIP allows data in the repository having a more complicated data storage structure compared to a relational database to be used for the predicate retrieval.

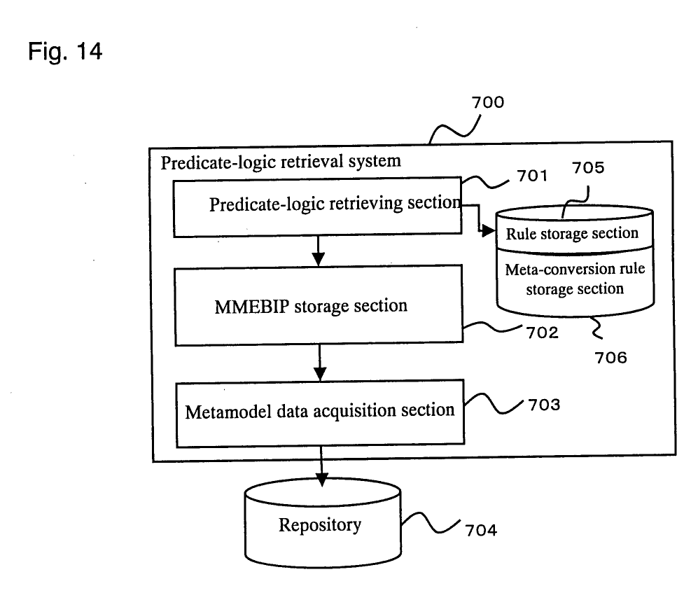

FIG. 14 shows a predicate-logic retrieval system according to a second embodiment of the present invention. The predicate-logic retrieval system 700 of the present embodiment includes a predicate-logic retrieving section 701, a MMEBIP storage section 702, a metamodel data acquisition section 703, a rule storage section 705 and a meta-conversion rule storage section 706, and retrieves data from a repository 704 storing therein data in a metamodel format.

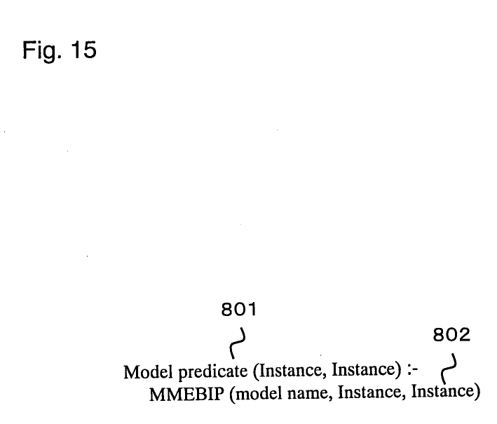

FIG. 15 shows an example of the meta-conversion rule stored in the meta-conversion rule storage section 706. The meta-conversion rule includes a head model predicate 801 and a body MMEBIP 802.

The predicate-logic retrieving section 701 refers to the meta-conversion rule storage section 705 in addition to the rule storage section 705 in step B5 shown in FIG. 5. If the predicate to be retrieved includes a model predicate, for example, 801 shown in FIG. 15, the predicate-logic retrieving section 701 refers to the meta-conversion rule storage section 706 to convert the model predicate 801 into the MMEBIP 802. Then, the predicate-logic retrieving section 701 executes identification processing in step A5 shown in FIG. 4 for the thus converted MMEBIP 802.

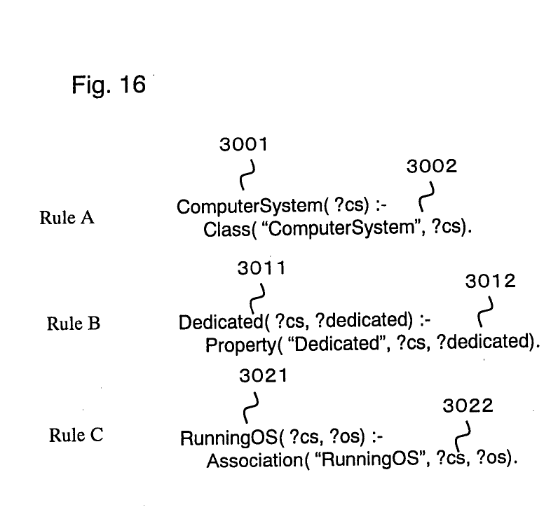

A concrete example of the second embodiment will be described hereinafter with reference to FIG. 16, which shows concrete examples of the meta-conversion rules. In FIG. 16, a rule A is used for converting a model predicate 3001, “ComputerSystem(?cs)” into a MMEBIP 3002, “Class(“ComputerSystem”, ?cs)”. Similarly, a rule B is used for converting a model predicate 3011, “Dedicated(?cs, ?dedicated)”, into a MMEBIP 3012, “Propery(“Dedicated, ?cs, ?dedicated)”, whereas a rule C is used for converting a model predicate 3021, “RunningOS(?cs, ?os)”, into a MMEBIP 3022, “Association(“RunningOS”, ?cs, ?os)”.

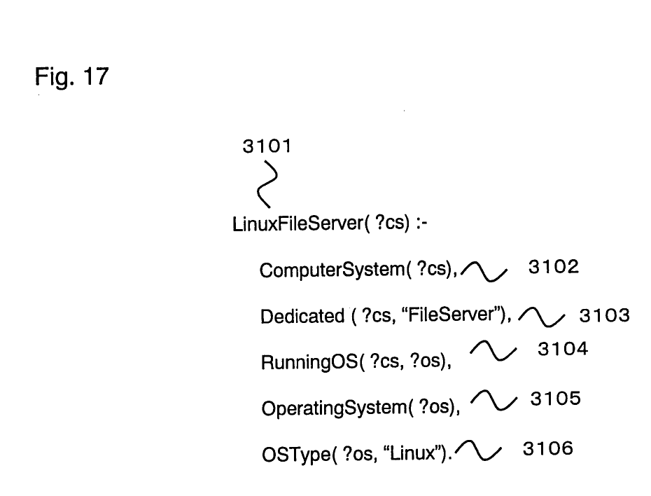

FIG. 17 shows examples of a rule stored in the rule storage section 705. The rule includes a head predicate 3101 and a plurality of body predicates 3102 to 3106. The body predicates 3102 to 3106 are model predicates each having a format of the model predicate 801 shown in FIG. 15. The model predicates 3102 to 3106 are defined by the meta-conversion rules stored in the meta-conversion rule storage section 706. The rule shown in FIG. 17 is equivalent to the rule shown in FIG. 13 after converting the model predicates into the MMEBIPs based on the meta-conversion rules.

The predicate-logic retrieving section 701, upon receiving a predicate query including “LinuxFileServer(?x)”, expands the predicate query in a plurality of model predicates 3102 to 3106 based on the rule shown in FIG. 17. In the subsequent predicate retrieval of the model predicate 3102, the predicate-logic retrieving section 701 converts the model predicate 3102, “ComputerSystem(?cs)”, into a “Class” predicate 3002 based on the rule A (FIG. 16) stored in the meta-conversion rule storage section 706. Thereafter, in the identification of the variable, the predicate-logic retrieving section 701 retrieves an instance of the “ComputerSystem” class from the repository 704 to identify the variable “cs” as a concrete value.

In the processing for the predicate retrieval of the “Dedicated” model predicate 3103, the predicate-logic retrieving section 701 first converts the model predicate 3103 into the “Property” predicate 3012 shown in FIG. 16 in the form of the MMEBIP. In this conversion, the first term of the model predicate 3103, after identification thereof as an instance, is substituted for the second term of the “Property” predicate 3012, whereas the second term, “FileServer”of the model predicate 3103 is substituted for the third term of the “Property” predicate. Subsequently, identification is executed for the converted “Property” predicate 3102, to thereby assure that the “Dedicated” property of the instance as identified is “FileServer”.

Thereafter, processings for the predicate queries of the model predicates 3104 to 3106 are also executed, while consecutively converting the model predicates 3104 to 3106 into the MMEBIPs based on the meta-conversion rules stored in the meta-conversion rule storage section. As a result of the processings, an instance of the “ComputerSystem” is obtained, wherein the “Dedicated” property is “FileServer”and the “OSType” property of an instance of the “OperatingSystem” associated via the “RunningOS” associator is “Linux”.

In the present embodiment, if the predicate query includes a model predicate equal to a head predicate of the meta-conversion rule stored in the meta-conversion rule storage section 706, the predicate-logic retrieving section 701 converts the model predicate into the MMEBIP based on the meta-conversion rule. Thus, even if the predicate query includes a model predicate different from the metamodels stored in the repository 704, the predicate-logic retrieving section 701 can retrieve data from the repository 704 for executing identification. This allows the user to create a predicate query with ease without using the MMEBIP in the creation of the predicate query, the MMEBIP having a higher degree of abstractness and thus a difficulty to create.

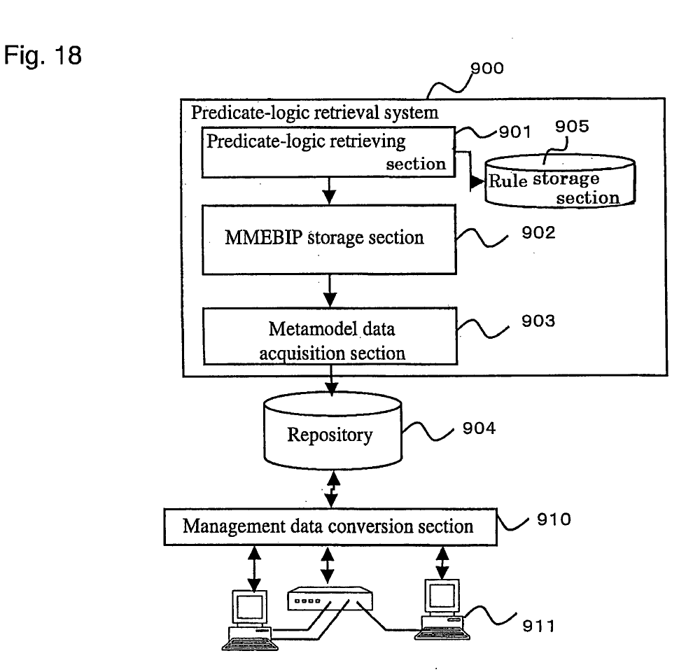

FIG. 18 shows a predicate-logic retrieval system according to a third embodiment of the present invention and used in a network management system for managing a computer network system 911. The predicate-logic retrieval system 900 of the present embodiment includes a management data conversion section (registry section) 910 in addition to a configuration similar to the configuration of the predicate-logic retrieval system 200 of the first embodiment. When the metamodel data acquisition section 903 requests metamodel data from the repository 904, the management data conversion section 910 responds to the request to thereby obtain most recent management data from the computer network system 911 and stores the most recent management data in the repository 904. In an alternative, the management data conversion section 910 may periodically obtain the most recent management data from the computer network system 911, and store the management data in the repository 904.

In the computer network system 911 managed by the network management system including the predicate-logic retrieval system 900, the management data, such as for servers or routers, is dynamically changed. The network management system may need data for the servers or routers in the computer network system 911. For example, there arises a case wherein the network management system should enumerate routers having a specific management data. In such a case, the management data conversion section 910 should obtain the most recent data from the routers and stores the most recent data in the repository 904. In the present embodiment, if the computer network system 911 dynamically changes its state with respect to the routers or servers, the predicate-logic retrieval system 900 can execute processing for a predicate query based on the dynamically changed state of the computer network system 911.

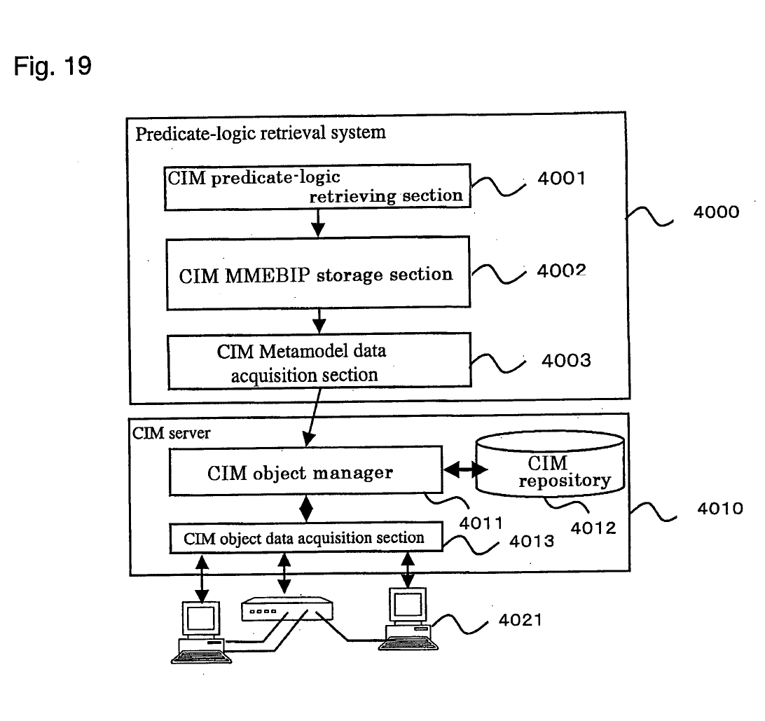

An example of the third embodiment will be described hereinafter with reference to FIG. 19. The predicate-logic retrieval system 4000 of this example includes a predicate-logic retrieving section 4001, a CIM MMEBIP storage section 4002, and a CIM metamodel processing section 4003, and obtains data from a CIM sever 4010 similarly to the predicate-logic retrieval system 2000 shown in FIG. 7. The CIM server 4010 includes a CIM object management section 4011, a CIM repository 4012, and a CIM object data acquisition section 4013 which receives data from a computer network system 4021. The CIM sever 4010 operates similarly to the CIM server 2010 shown in FIG. 7 except for the operation of the CIM object data acquisition section 4013.

The computer network system 4021 to be managed by a network management system including the predicate-logic retrieval system 4000 of the present embodiment stores therein data in a management information base (MIB) format. The CIM object data acquisition section 4013 collects data from the computer network system 4021, converts the collected data into the format of the CIM object and stores the resultant data in the CIM repository 4012. If the user issues a predicate query such as including a predicate, “LinuxFileServer(?x), the predicate-logic retrieval system 4000 obtains instances of servers, which operate as Linux file server, in the computer network system 4021 based on the data stored in the CIM repository 4012. Thus, the computer network system 4021 can be managed by the network management system irrespective of a dynamically changed configuration of the computer network system.

In the first embodiment, it is described that four instances 2401 to 2404 of the “ComputerSystem” class, obtained based on the get-function, are stored in the CIM metamodel data acquisition section 2003 during the first identification of the “Class” predicate 2502 and one of the remaining instances 2401 to 2404 is extracted during the re-identification of the predicate 2502. In an alternative, the re-identification of the predicate 2502 may be executed similarly to the first identification by acquiring the data again from the CIM server 2010.

There is a possible problem that if the CIM metamodel data acquisition section 2003 stores therein the data retrieved from the CIM server 2010, then the corresponding data, such as a property of the instance, stored in the CIM repository 2012 may be updated before the data in the CIM metamodel data acquisition section 2003 is delivered to the predicate-logic retrieving section 2001. For solving this problem, the CIM metamodel data acquisition section 2003 should preferably issue a request for receiving information of a data update event from the CIM server 2010 if the CIM server 2010 updates the data stored in the CIM repository 2012. In this case, if the CIM metamodel data acquisition section 2003 receives information of the data update event from the CIM server 2010, the CIM data acquisition section 2003 discards the own data and again receives the data from the CIM server 2010.

The rules in the rule storage section and the meta-conversion rules in the meta-conversion rule storage section may be combined together, wherein at least one of the rules thus combined may include a head model predicate and at least one body MMEBIP.

The predicate-logic retrieval system of the present invention can be used as a retrieval system for retrieving data from a knowledge management database, and a retrieval system for retrieving data of objects to be managed in a management system. The retrieval of the object data includes a judgement as to whether or not there is any association between the managed objects and/or enumeration of objects associated with a specified object via a specific associator. The predicate-logic retrieval system can be also used for transmission and/or conversion between different programs or between different repositories.

Since the above embodiments are described only for examples, the present invention is not limited to the above embodiments and various modifications or alterations can be easily made therefrom by those skilled in the art without departing from the scope of the present invention.

What is claimed is:

1. A predicate-logic retrieval system for responding to a predicate query to retrieve data from a repository, the repository storing therein data in a metamodel format defined using a plurality of metamodel elements, said retrieval system comprising:
a predicate retrieving section for referring based on the predicate query to a predicate storage section, which stores therein a metamodel-element built-in predicate (MMEBIP) and at least one get-function in association, to retrieve said get-function corresponding to the predicate query;
a data acquisition section for retrieving data from the repository based on said get-function; and
a variable identification section for executing an identification processing and a back-tracking processing both based on data acquired by said data acquisition section, to return an answer for the predicate query, is said answer including a true or false statement for the predicate query or a value of a free variable in the predicate query that provides a truth for the predicate query.

2. The predicate-logic retrieval system according to claim 1, wherein said predicate retrieving section retrieves a rule stored in a rule storage section storing at least one rule including a head predicate and at least one body predicate, to replace a predicate of the predicate-logic query with said body predicate of said rule retrieved.

3. The predicate-logic retrieval system according to claim 2, wherein said body predicate is a MMEBIP, and said head predicate is a model predicate derived from one of said MMEBIPs.

4. The predicate-logic retrieval system according to claim 1, wherein said variable identification section performs said back-tracking processing using one of a plurality of data acquired by said data acquisition section, said one of said plurality of data being not used in a preceding identification processing.

5. The predicate-logic retrieval system according to claim 1, further comprising a data registry section for entering monitored data in said repository, said monitored data being obtained by monitoring a computer network system.

6. The predicate-logic retrieval system according to claim 1, further comprising a meta-conversion rule storage section storing therein at least one conversion rule including a head model predicate derived from one of said MMEBIPs and a body MMEBIP.

7. A method for retrieving data from a repository based on a predicate query, the repository storing therein data in a metamodel format defined using a plurality of metamodel elements, said method comprising:
referring based on the predicate query to a predicate storage section, which stores therein a metamodel-element built-in predicate (MMEBIP) and at least one get-function in association, to retrieve said get-function corresponding to the predicate query;
retrieving data from the repository based on said get-function; and
executing an identification processing and a back-tracking processing both based on data acquired by said data acquisition section, to return an answer for the predicate query, said answer including a true or false statement for the predicate query or a value of a free variable in the predicate query that provides a truth for the predicate query.

8. The method according to claim 7, further comprising retrieving a rule stored in a rule storage section storing at least one rule including a head predicate and at least one body predicate, to replace a predicate of the predicate-logic query with said body predicate of said rule retrieved.

9. The method according to claim 8, wherein said body predicate is a MMEBIP, and said head predicate is a model predicate derived from one of said MMEBIPs.

10. The method according to claim 7, wherein said executing of said back-tracking processing uses one of a plurality of data retrieved in said retrieving, said one of said plurality of data being not used in a preceding identification processing.

11. The method according to claim 7, further comprising entering monitored data in said repository, said monitored data being obtained by monitoring a computer network system.

12. The method according to claim 7, further comprising retrieving a meta-conversion rule storage section storing therein at least one conversion rule including a head model predicate derived from one of said MMEBIPs and a body MMEBIP.

13. A program running on a computer system for retrieving data from a repository based on a predicate query, the repository storing therein data in a metamodel format defined using a plurality of metamodel elements, said program defining:
means for referring based on the predicate query to a predicate storage section, which stores therein a metamodel-element built-in predicate (MMEBIP) and at least one get-function in association, to retrieve said get-function corresponding to the predicate query;
means for retrieving data from the repository based on said get-function; and
means for executing an identification processing and a back-tracking processing both based on data acquired by said data acquisition section, to return an answer for the predicate query, said answer including a true or false statement for the predicate query or a value of a free variable in the predicate query that provides a truth for the predicate query.

14. The program according to claim 13, further defining means for retrieving a rule stored in a rule storage section storing at least one rule including a head predicate and at least one body predicate, to replace a predicate of the predicate-logic query with said body predicate of said rule retrieved.

15. The program to claim 14, wherein said body predicate is a MMEBIP, and said head predicate is a model predicate derived from one of said MMEBIPs.

16. The program according to claim 13, wherein said means for executing executes said back-tracking processing using one of a plurality of data retrieved in said retrieving, said one of said plurality of data being not used in a preceding identification processing.

17. The program according to claim 13, further defining means for entering monitored data in said repository, said monitored data being obtained by monitoring a computer network system.

18. The program according to claim 13, further defining means for retrieving a meta-conversion rule storage section storing therein at least one conversion rule including a head model predicate derived from one of said MMEBIPs and a body MMEBIP.
